(19) United States
(12) Patent Application Publication
(10) Pub. No.: US 2004/0026334 A1
(43) Pub. Date: Feb. 12, 2004

(54) Method for removing hydrogen sulfide and increasing the rate of biodegradation in animal waste pits and lagoons

(75) Inventors: David R. Soll, Iowa City, IA (US); Karla J. Daniels, Iowa City, IA (US); Donovan P. Gibson, Lohe Tree, IA (US); Joshua R. Davis, Alden, IA (US)

Correspondence Address: FOLEY AND LARDNER, SUITE 500, 3000 K STREET NW, WASHINGTON, DC, 20007, US

(73) Assignee: The University of Iowa Research Foundation

(21) Appl. No.: 10/213,435

(22) Filed: Aug. 7, 2002

(51) Int. Cl. C02F 1/34

(52) U.S. Cl. 210/748; 210/87; 210/138; 210/143; 210/542; 210/764; 210/739

(57) ABSTRACT

A treatment system is provided for liquefied livestock waste contained in a slurry pit of a livestock confinement building or lagoon. Waste slurry is pumped through a sonication chamber where it is treated with ultrasound and energy density. The configuration of sonicator probes, the duration of treatment, and the sonication chamber design subject the animal waster therein to maximum sonic cavitation. The treatment should be such that the particle size of the waste is sufficiently reduced to suspend or dissolve the particles permanently, which greatly enhances the speed of biodegradation. Where the pits are under confinement buildings, the waste slurry may be recycled after treatment back into the slurry pit. In other cases, the waste slurry may be treated and then passed to a transient storage tank for trapping methane, and then to a lagoon, or passed directly to a lagoon.

### BACKGROUND OF THE INVENTION

1. Field of the Invention

The present invention relates to the field of treating animal waste to reduce the odor content thereof. More particularly, the invention relates to a system for increasing the solubility of animal waste using sonication to aid biological breakdown of the waste.

2. Description of the Related Art

Animal agriculture in the United States is a $100 billion per year industry. The U.S. is the world leader in the efficient production of meat, milk, poultry and eggs, largely attributable to increased development of concentrated animal feeding operations.

The concentration of large numbers of livestock on individual farms raises challenges in the management of livestock waste. As a result of the concentration of animals in confinement facilities, large amounts of animal waste must be managed in such a way that it does not threaten water supplies including rivers, oceans, and lakes. It addition, it is important that the waste does not produce unpleasant odors that affect the quality of life of neighbors, and does not pose a health hazard to workers and livestock. There are also concerns of exposure of workers and animals to toxic gases inside confinement buildings.

In response to these concerns, the livestock industry is under considerable pressure by state and local government to ensure that these nuisances and hazards are adequately addressed. In the United States, swine operations have adopted two predominant waste management strategies: (a) slurry storage under slatted feeding floors or in outside storage tanks; and (b) storage in anaerobic lagoons which are usually exposed to the atmosphere.

The slurry storage systems tend to be favored in northern states such as the upper Midwest and Northern Great Plains, and where the terrain or geology does not favor construction of earthen lagoons. there are concerns, however, about the effects of gases emitted from under-floor storage pits on animal health and performance, as well as worker health particularly because the release of hydrogen sulfide can be life threatening for man and animal. Eventually, accumulated waste slurry must be removed from these pits. Untreated waste slurry in pits generates high levels of hydrogen sulfide and other odorous and toxic gases, resulting for the most part from the sludge that settles into anaerobic mud at the pit bottom. Release of gases is especially dangerous when the content of a pit is agitated during removal; this poses increased risk for animals and workers. When applied to fields as fertilizer, the content of a waste pit may cause odors that spread to neighboring farms and communities.

Lagoon systems are more common in southern states and in the southern portions of the Midwest and Great Plains, where warmer temperatures most of the year promote biodegradation. Lagoons provide some treatment to the waste, but still produce odors primarily as a result of anaerobic biodegradation at the lagoon bottom. Eventually, lagoons must also be cleaned-out because of sludge accumulation. Disposal of these sludge solids represents a similar problem.

Several technologies are used currently to improve the air quality near confined animal feeding operation. Impermeable covers have been applied that hold gases and odors inside tanks or lagoons. Biocovers such as cornstalks or straw have been applied, which reduce diffusion from the liquid surface to the air above. Aeration facilitates elimination of odor and undesirable gases, but requires large amounts of energy. Many additives are available to alter the chemistry or microbiology of pits or lagoons including substances and microbes that affect pH, chemical oxidation, precipitators, and odor. However, a study of 35 additives, conducted by the National Pork Board, found that none of these additives decreased odors at a 95% confidence level.

Thus, although a number of technologies exist for reducing emissions from confined animal feeding operations, none of these technologies has solved the problems of toxic and odorous gas emissions in an economically feasible manner. For these and other reasons, a new system is needed which can effectively and economically reduce the odor content of animal waste.

### SUMMARY OF THE INVENTION

A purpose of the present invention is to treat liquefied waste from confined animal feeding operations. Preferably, the ultrasound treatment of the waste is such as to cause several physical and chemical changes to the slurry, which in turn facilitate further changes during subsequent storage. Through sonication, the treated waste slurry exhibits decreased particle size and increased suspended solids. The suspension of solids greatly increases hydrolysis, which enhances the efficiency of the biological breakdown of the waste. The increased efficiency is due, at least in part, to improved oxidation of hydrogen sulfide and, therefore, improved anaerobic digestion of industrial waste. See, e.g., Katronarow et al., ENV. SCI. TECH. 26: 2420-2428 (1992); Tiehm et al., WATER RES. 35: 2003-2009 (2001); Neis et al., WAT. SCI. TECH. 36: 121-128 (1997). See also Fernandes et al., CAN. AG. ENG. 33: 373-379 (1991) (combining ultrasound treatment with a bioreactor).

The invention consists of systems and processes based on ultrasound for the treatment of liquefied waste from confined animal feeding operations contained in a slurry pit of a livestock confinement building or lagoon. Waste collected in a slurry pit beneath slatted floors in a livestock confinement building is recycled through a sonication chamber that reduces waste particle size and removes hydrogen sulfide gas. In the chamber, the waste is subjected to sound energy at frequencies between about 5 kHz and about 100 kHz (and an energy density of between 10 watts/cm² and 50 watt/cm²) for periods between about 5 seconds and about 5 minutes. The configuration of sonicator probes, the duration of treatment, and the design of the sonication chamber effect maximum sonic cavitation of animal waste in chamber.

The ultrasonic energy generates cavitational forces by the adiabatic collapse of micro-bubbles in the liquid medium. The treatment preferably is such that the particle size of the waste is sufficiently reduced to suspend or dissolve the particles permanently, which greatly enhances the speed of biodegradation. After the sonication period has ended, new liquid waste is pumped into the chamber from the pit below. The sonicated waste may be: (a) returned to the storage pit, where it may undergo further biological degradation; (b) pumped into a holding tank capped with a methane cap, e.g., for later use as fertilizer; (c) pumped into a lagoon for anaerobic degradation; or (d) passed to a transient storage tank, for trapping methane, and then to a lagoon.

The benefits of these related treatments may include any one or more of the following: (a) a dramatic reduction in hydrogen sulfide emission; (b) a decrease in ammonia emission; (c) an increase in the rate of methane production; (d) an increase in the rate of biodegradation; (e) a decrease in odor; (f) a decrease in sludge solids; (g) an improved retention of nutrients in the waste thereby enhancing its use as a fertilizer; and (h) a reduction in waste mass. In achieving one or more of these benefits, the sonication and pump power supplies may be controlled by a controller that terminates the power to the pump when the sonicator is on and terminates the power to the sonicator when the pump is on. Further, the controller may work in conjunction with an electrical timing device or pump flow monitor.

These benefits accrue to a system, according the invention, that has a sonication apparatus for treating a fluid containing solid biological waste. Pursuant to the invention, a suitable apparatus includes a substantially cylindrical sidewall that defines a chamber having a longitudinal axis therethrough. An inlet port is provided at a first end of the sidewall, and an outlet port, in fluid communication with the inlet port, is provided at a second end of the sidewall. A plurality of transducers are arranged in a substantially linear manner. Each of the transducers is oriented substantially normal to the axis of the chamber, is substantially provided on an exterior side of the sidewall, and comprises a probe which extends at least partially into the chamber. When the fluid having solid biological waste therein is provided in the chamber and the probes are at least partially emerged in the fluid, the probes are adapted to emit sound having a frequency adapted to facilitate dissolving or suspending the solid biological waste in the fluid.

The sonication apparatus also may include a controller adapted to cause each of the probes to emit sound simultaneously. Further, the probes may be adapted to emit sound having a frequency between about 5 kHz and about 100 kHz; for example, about 20 kHz. In addition, the controller may be adapted to cause the probes to emit sound constantly for between about one minute and about ten minutes, such as for example, about five minutes.

The invention also contemplates an entire sonication system for treating a fluid having solid biological waste therein. The system includes a source containing the fluid having the solid biological waste therein. A pump is provided which has an inlet connected to a first pipe which is in fluid communication with the source; an outlet of the pump is connected to a second pipe. A sonication apparatus of the type previously described is provided wherein an inlet port thereof is connected to the second pipe and an outlet port thereof is connected to a third pipe. In addition, the third pipe may be in fluid communication with the source, a lagoon, a storage tank, or a bioreactor.

The sonication system may also include a controller adapted to control the flow of power to the probes and to cause each of the probes to emit sound simultaneously. The controller may be further adapted to control power to the pump and to alternate power between the pump and the probes.

Further, the probes may be adapted to emit sound having a frequency between about 5 kHz and about 100 kHz, such as for example about 20 kHz. In addition, the controller may be adapted to cause the probes to emit sound constantly for between about one minute and about ten minutes, such as for example, about five minutes.

The system also may include at least one of a flow rate monitor and a timer. The flow rate monitor is preferably adapted to monitor the flow rate of the fluid having the solid biological waste therein when moving into the chamber whereas the timer is preferably adapted to determine, based on a fixed flow rate, when the chamber is full of the fluid having the biological waste therein. If a flow rate monitor is included, the controller is preferably electrically connected thereto and is adapted to determine when the chamber is full of the fluid having the solid biological waste therein, the determination being based on the flow rate measured by the flow rate monitor and the volume of the chamber.

The controller may determine that the chamber is full by working in conjunction with a flow rate monitor and/or a timer, and subsequently may terminate a supply power to the pump and initiate a supply of power to the probes. Alternatively, the system may include a constantly powered pump, such that the fluid carrying the solid biological waste continuously flows through the chamber.

The present invention contemplates both a method of controlling a sonication system, for treating a fluid containing solid biological waste, and a method of treating a fluid having solid biological waste therein. With respect to the former method, the system in question includes a pump and a sonication chamber in fluid communication with the pump. The sonication chamber includes a plurality of probes, each of which is adapted to emit sound having a frequency adapted to facilitate dissolving or suspending the solid biological waste in the fluid. A flow rate monitor is adapted to monitor the flow rate of the fluid having solid biological waste therein when moving into the chamber. The control system includes: (a) providing a source containing the fluid having the solid biological waste therein, the source being in fluid communication with the pump; (b) determining when the chamber is full of the fluid having the solid biological waste therein, the determination being undertaken by a controller and being based on the flow rate measured by the flow rate monitor and the volume of the chamber, the flow rate monitor being electrically connected to the controller; (c) terminating, by means of the controller, the flow of power to the pump when the controller determines that the chamber is full; and (d) initiating a flow of power to the probes after terminating the flow of power to the pump, wherein the controller is adapted to cause each of said probes to emit sound simultaneously.

The control system method may additionally include: (e) terminating the flow of power to the probes after a predetermined period of time in which at least some of the solid biological waste becomes dissolved or suspended in the fluid in response to the sound emitted by the probes; (f) re-initiating a flow of power to the pump after terminating the flow of power to the probes; and (g) replacing the fluid having the biological waste dissolved or suspended therein in the chamber with a new quantity of fluid having solid biological waste therein as pumped out of the source by the pump, when the flow of power is re-initiated in the pump.

Similar to the probes of the aforementioned sonication apparatus, probes of the sonication apparatus used in the method of system control are preferably adapted to emit sound having a frequency between about 5 kHz and 100 kHz, such as, for example, 20 kHz. Further, the step of initiating a flow of power to the probes may have a duration of about one minute to about ten minutes and the step of initiating a flow of power to the probes may have a duration of about five minutes.

A method of the invention for treating a fluid that contains biological waste also includes a system that comprises a pump and, in fluid communication with it, a sonication chamber. The latter component includes a plurality of probes, each adapted to emit sound having a frequency adapted to facilitate dissolving or suspending the solid biological waste in the fluid. The method of treating the fluid includes: (a) providing a source containing the fluid having the solid biological waste therein, the source being in fluid communication with the pump; (b) pumping the fluid from the source and into the sonication chamber; (c) determining when the chamber is full of the fluid having the solid biological waste therein, the determination being undertaken by a controller; (d) sonicating the fluid in the chamber for a predetermined period of time to yield sonicated fluid; and (e) moving the sonicated fluid into at least one of the source, a lagoon, a storage tank, or a bioreactor.

These and other features, aspects, and advantages of the present invention will become more apparent from the following description, appended claims, and accompanying exemplary embodiments shown in the drawings.

### BRIEF DESCRIPTION OF THE DRAWINGS

The accompanying drawings, which are incorporated in and constitute a part of the specification, illustrate an embodiment of the invention and together with the description, serve to explain the principles of the invention.

FIG. 1 is a schematic view of a sonication treatment system including a control system;

FIG. 2 is a cross sectional view of a sonication apparatus having a sonication chamber therein, the figure showing a plurality of substantially linearly arranged transducers each of which has a probe which projects at least partially into the chamber;

FIG. 3 is a schematic view of a sonication apparatus having three transducers each of each is connected to an individual power supply which are, in turn, connected to a controller;

FIG. 4 is a cross sectional view of a high intensity, pass-through sonication chamber having a plurality of high intensity ultrasound probes thereon;

FIG. 5 shows a comparison of micrographs depicting sonicated and non-sonicated biological waste;

FIG. 6A depicts an increase in dissolved solids after sonication of biological waste; FIG. 6B depicts an increase in volatile solids after sonication of biological waste

FIG. 7 depicts an increase of chemical oxygen demand with ultrasound treatment of raw hog waste;

FIG. 8 depicts a decrease of hydrogen sulfide concentration of sonicated biological waste versus time;

FIG. 9A depicts chemical oxygen demand versus time for an anaerobic reactor for sonicated and non-sonicated waste; FIG. 9B depicts a percentage of the maximum chemical oxygen demand versus time for an anaerobic reactor for sonicated and non-sonicated waste;

FIG. 10 depicts a decreased level of hydrogen sulfide after ten days of various treatments;

FIG. 11 depicts a decreased hydrogen sulfide level in the sonicated treatment groups of FIG. 10 after a 90-day period in a bioreactor;

FIG. 12 depicts the levels of hydrogen sulfide emissions in the sonicated treatment groups of FIG. 11 after agitation at the end of the 90-day period in the bioreactor.

### DETAILED DESCRIPTION OF THE PREFERRED EMBODIMENT

Reference will now be made in detail to a presently preferred embodiment of the invention, which is illustrated in the drawings. An effort has been made to use the same reference numbers throughout the drawings to refer to the same or like parts.

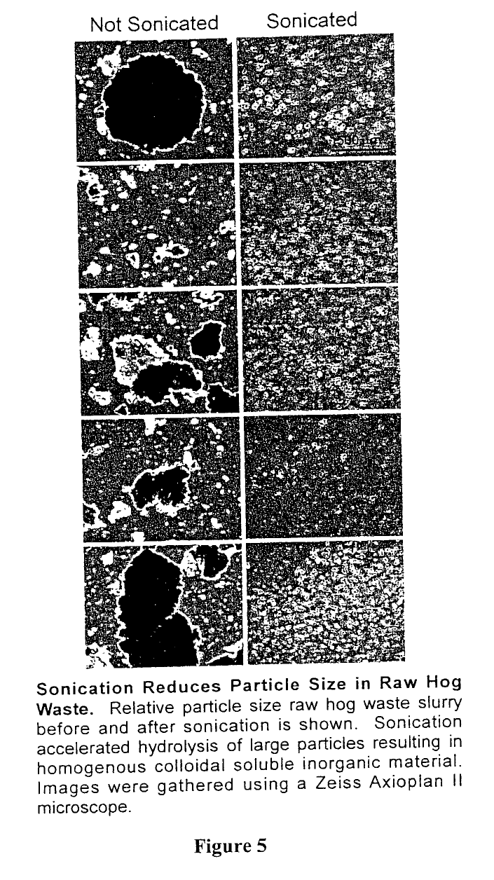

New systems have been developed based on ultrasound for the treatment of liquefied biological waste in confined animal feeding operations. Ultrasonic energy is applied to the waste in a sonication chamber at frequencies from between about 5 kHz and about 100 kHz, and preferably at about 20 kHz. As a result, the solid biological matter in the waste is more readily dissolved or suspended in the fluid, as shown in FIG. 5.

It is currently believed that acoustic energy is carried through the liquid by oscillation of the liquid molecules in the direction of propagation. The oscillating of the liquid produces alternating adiabatic compressions and decompressions together with corresponding increases and decreases in density and temperature. If the periodic decreases of pressure in the liquid are sufficiently high during the negative pressure phase, the cohesive forces of the liquid may be exceeded which can cause the growth and subsequent collapse of small bubbles. Extreme transient conditions exist in the interior of the collapsing bubbles yielding temperatures approaching 5000° K and pressures of several hundred atmospheres. See Suslick et al., J. AM. CHEM. SOC. 108: 5641 (1986); Suslick, K. S., ULTRASOUND ITS CHEMICAL, PHYSICAL, AND BIOLOGICAL EFFECTS (1988).

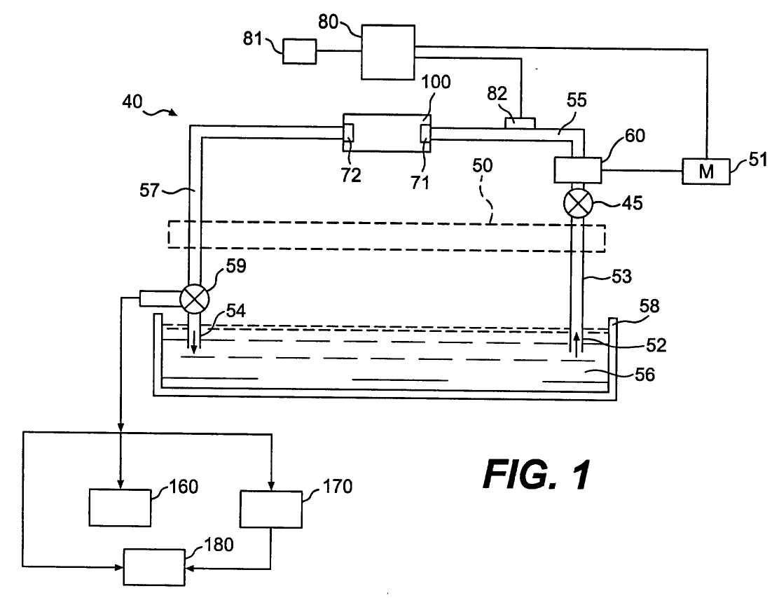

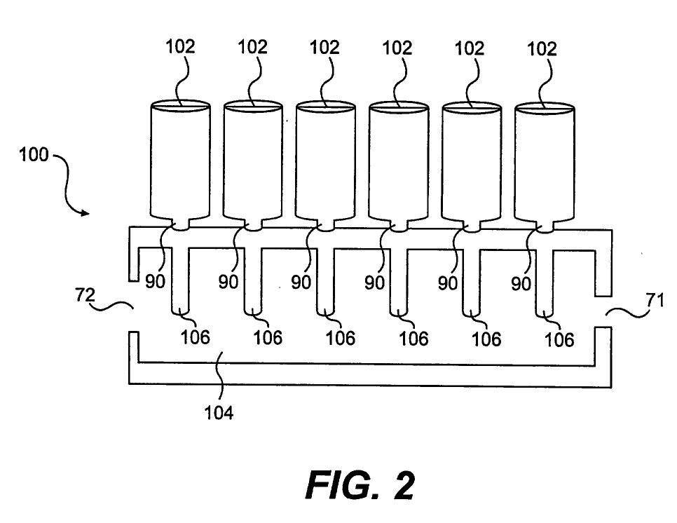

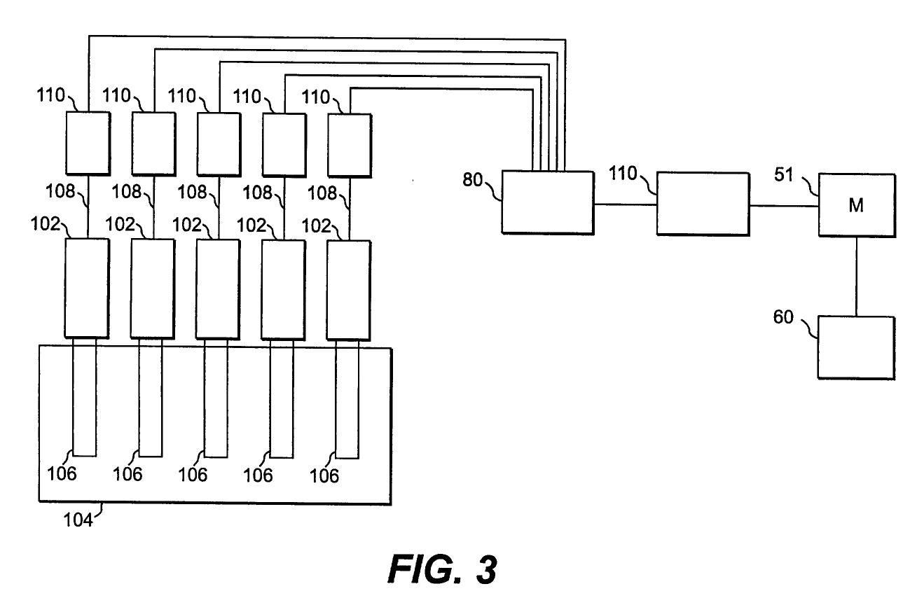

The system and one embodiment of a sonication apparatus employed by the system are shown in FIGS. 1, 2, and 3 in which FIG. 1 is a schematic view of a sonication treatment system including a control system, FIG. 2 is a cross section view of a sonication apparatus having a sonication chamber therein (the figure showing a plurality of substantially linearly arranged transducers each of which has a probe which projects at least partially into the chamber), and FIG. 3 is a schematic view of a sonication apparatus having three transducers each of each is connected to an individual power supply which are, in turn, connected to a controller.

The recycling system 40 used for the treatment of liquefied biological waste (hereinafter “waste”) 56 in a slurry pit 58 under a confinement building according to the present invention is illustrated diagrammatically in FIG. 1. Generally, waste 56 of between about 2% and about 6% in total solids content is pumped from the slurry pit 58 to the sonication apparatus 100 by a pump 60 driven by a motor 51. The pump 60 can be any suitable pump (such as, for example, a positive displace pump) which can pump at least one gallon per minute and which is capable of pumping liquids of varying viscosity and with high solid content. However, a preferable pump has proven to be a Tarby model 100-1PL4CDQ heavy duty progressive cavity pump with a ½ hp 230 v single phase, 1750 rpm gear motor.

The pump 60 is placed on a slatted floor 50 above the slurry pit 58 and is attached to an intake pipe 53 that extends to a level approximately one foot above the bottom of the slurry pit 58. Any pipe which is wide enough to pump sewage may be used for the intake pipe 53. However, one preferable pipe is a PVC pipe of about three inches in diameter. The pump 60 is preferably provided with a back-flow valve 45 to prevent (or at least greatly reduce the likelihood of) waste 56 from flowing back toward the slurry pit 58. The back flow valve 45 can be any suitable valve including a check valve, a solenoid, etc.

An outlet pipe 55, capable of transporting liquid waste, is attached to the discharge side of the pump 60 and is connected to a sonication apparatus 100. Whereas the intake pipe 53 is preferably about three inches in diameter, the outlet pipe 55 need only be preferably about two inches in diameter. In addition, similar to the intake pipe 53, the outlet pipe is preferably made out of PVC.

The sonication apparatus 100 has an intake port 71 on one end, a discharge port 72 on the opposite end, and a substantially cylindrical chamber 104 therebetween which holds a volume of approximately five gallons of liquid. Although the shape of the chamber 104 may be altered for more effective cavitation, a preferable chamber 104 is about six inches in diameter and about three feet in length. At the top of the apparatus 100, a plurality of high intensity ultrasound transducers 102 are linearly attached using o-ring seals 90. Each of the transducers 102 comprises a probe 106 which extends approximately two inches into the waste 56 in the chamber 104. Although six transducers 102 are shown in FIG. 2, the invention contemplates any number of transducers 102. In general, per give time period, with more transducers 102 comes enhanced sonication results, i.e., the degree to which the waste 56 is dissolved or suspended in the fluid is increased proportionally to the number of transducers 102. In addition, any of a variety of transducers can be used. However, a preferable transducer is a piezocermaic transducer such as that found in the VCX 600 sonicator, manufactured by Sonics and Materials, Inc.

FIG. 3 shows three transducers 102 connected to a sonication chamber 104. Each of the transducers 102 is provided with a power cord 108 leading to a power source 110. In turn, each of the power sources 110 is connected to a controller 80. As a result thereof, the controller 80 is adapted to control power to the transducers 102 via the power sources 110. In addition, the controller 80 is also connected to a power supply 110 leading to the motor 51 which drives the pump 60 and, therefore, the controller 80 controls power to the pump 60. Further, the controller 80 may be adapted to alternate power between the pump 60 and the transducers 102 such that only one of the pump 60 and the transducers 102 is operable at a given time.

The controller also may be connected to a timer 81 and/or a flow rate monitor 82. While maintaining a substantially fixed flow rate, the timer 81 can be used to instruct the controller 80 that a sufficient amount of waste 56 has entered the sonication chamber 104 to fill it. At that time: (a) the controller 80 can terminate power to the pump 60; (b) the controller 80 can initiate power to the transducers 102 to begin the sonication step in the overall system; and (c) the timer 81 can begin counting a sonication period. When the sonication period has elapsed (i.e., when waste 56 in the sonication chamber 104 is sufficiently sonicated), the timer 81 can instruct the controller 80 to terminate power to the transducers 102 and reinitiate power to the pump 60, in order that a new quantity of waste 56 can be pumped into the chamber 104.

Similar to the timer 81, a flow-rate motor 82 can be provided. By monitoring the flow rate (which may vary) of the waste 56 in the system and working with a fixed volume chamber 104, the flow rate monitor 82 can calculate when the cylinder 104 is full of waste 56. When the flow rate monitor 82 calculates that the chamber 104 is full, it can instruct the controller 80 to terminate power to the pump 60 and initiate power to the transducers 102 in the same manner as the timer 81. However, as when the pump 60 is stopped there is a zero flow rate of waste, a timer (such as the timer 81 previously described) will need determine when the waste 56 in the chamber 104 is sufficiently sonicated.

Preferably, the controller 80, timer 81, and the power supplies 110 are located in a building in a clean atmosphere remote from the building housing the livestock and the slurry pit 58. First, the clean environment should facilitate the integrity of the controller 80, the timer 81, and the power supplies 110. Second, it is preferable to insulate a day-to-day operator from the environment of the slurry pit 58 to eliminate or at least greatly reduce the operator's exposure to harmful odors such as hydrogen sulfide.

The controller 80, the timer 81, and the flow rate monitor 82 are preferably set to allow the system to operate automatically (i.e., the pump 60 and the sonication apparatus 100 will be automatically controlled). The pump 60 for the present invention is set to pump between about one minute and about five minutes, preferably at about two minutes, which is the approximate time it takes to fill the sonication chamber. When the pump 60 stops, the sonication apparatus 100 turns on and runs between about one minute and about ten minutes, preferably about five minutes. After sonication, the sonicated waste 56 is pumped out of the chamber 104 via the discharge port 72 and into a return pipe 57.

After being pumped into the return pipe 57, the sonicated waste 56 enters a valve 59 which, like the previous valve 45, may be any suitable valve such as a check valve, a solenoid valve, etc. At this juncture, the sonicated waste 56 may be directed: (I) to a concrete holding tank 160 where it can be stored until it is used for fertilizer; (II) to an anaerobic lagoon 170; (III) to an anaerobic bioreactor 180; or (IV) back into the slurry pit 58 to be cycled through the system for at least one additional cycle. In addition, if the sonicated waste 56 is directed to an anaerobic lagoon 170, it may subsequently be directed to a bioreactor 180.

With respect to the first option, sonicated waste 56 from a concentrated animal feeding operation may be transferred to a collecting tank 160 to be stored for later use as fertilizer. This transfer preferably would be done using gravity flow or with a pump. From the collection tank 160, the sonicated waste 56 could be pumped to flow through a second sonication device which may be similar to that previously described. The sonicated waste 56 would then be held for up to about one year, before it could be used as fertilizer.

With respect to the second option, sonicated waste 56 from a confined animal feeding operation would be treated as in Option I with the following exception. Instead of being pumped into a holding tank 160, the waste 56 would be pumped into an anaerobic lagoon 170 in which the waste 56 would be stored and diluted with water. The lagoon 170 may act as a biological tank, in which the waste 56 is partially decomposed before it is used on land as a fertilizer resource in the form of irrigation liquid.

The sonicated waste 56 in an anaerobic lagoon 170 would have advantages over non-sonicated waste slurry therein. In particular, the sonicated waste 56 would have up to about 30% greater bioavailability than the non-sonicated waste and would decompose at a faster rate with the added advantage of increased biogas production. Further, the sonicated waste 56 would produce much less sludge build-up in this lagoon 170 thereby extending the time period between lagoon cleanings.

With respect to the third option, there are currently other technologies in animal waste treatment that could benefit from the added treatment of ultrasound. Two of the treatment methods are both types of batch bio-reactors. The first one is called an Anaerobic Digester and the other typed is called a Sequencing Batch Reactor. Sonicated waste slurry, as previously described, before going into either of these types of reactors would greatly increase their efficiency.

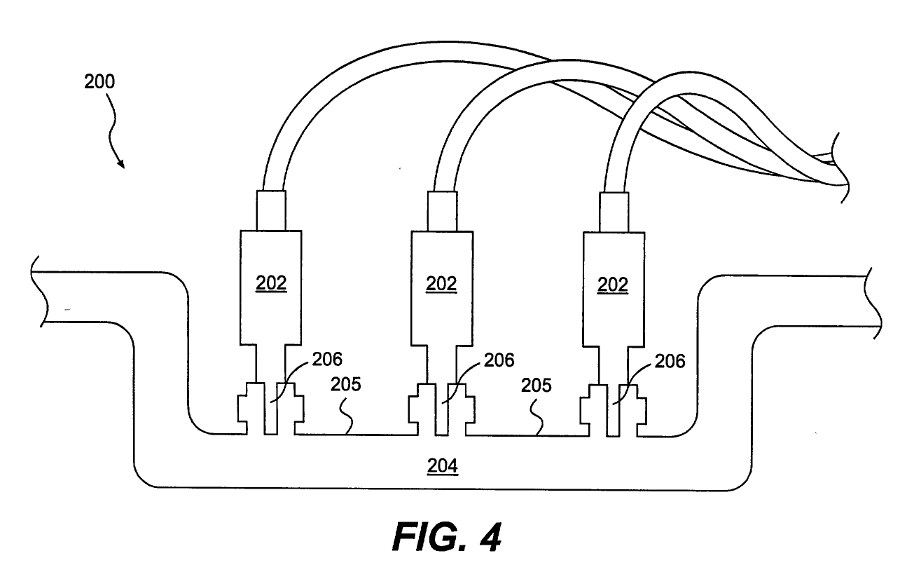

FIG. 4 is a cross sectional view of an alternative pass-through, high intensity sonication apparatus 200 which may be used for continuously treating liquefied waste. Liquefied waste, between about 2% and about 6% solid content, may be pumped or transferred by gravity flow directly through a flow-through sonication chamber 204 at a designated rate. The flow-through chamber 204 may process up to about three gallons of waste per minute with good results and may be constructed of two inch PVC schedule 40 pipe. Further, the chamber 204 would have a plurality (e.g., three) of custom-designed, high intensity ultrasound transducers 202 having probes 206 therein; the transducers 202 being manufactured to fit into a two inch PVC T-fitting. One such high intensity ultrasound transducer is the AO7657PRB sonicator, manufactured by Sonics and Materials, Inc., which contains a probe having a diameter of one inch at the tip. The tip of the probe 206 may be even with the top 205 of the chamber 204, so that all of the liquid waste passes under the probe and through an extremely intense cavitational field.

Regardless of the sonication apparatus used, the ultrasound treatment should be such that it causes physical and chemical changes to the waste 56, which then facilitates changes during subsequent storage. Further, in either apparatus 100/200, the chamber 104/204 may be modified by increasing the number of sonicator probes 106/206. The benefit of additional probes 106/206 is a greater rate of treatment. For example, a two-fold increase in the number of probes would double the volume of waste 56 which could be treated for a given period of time.

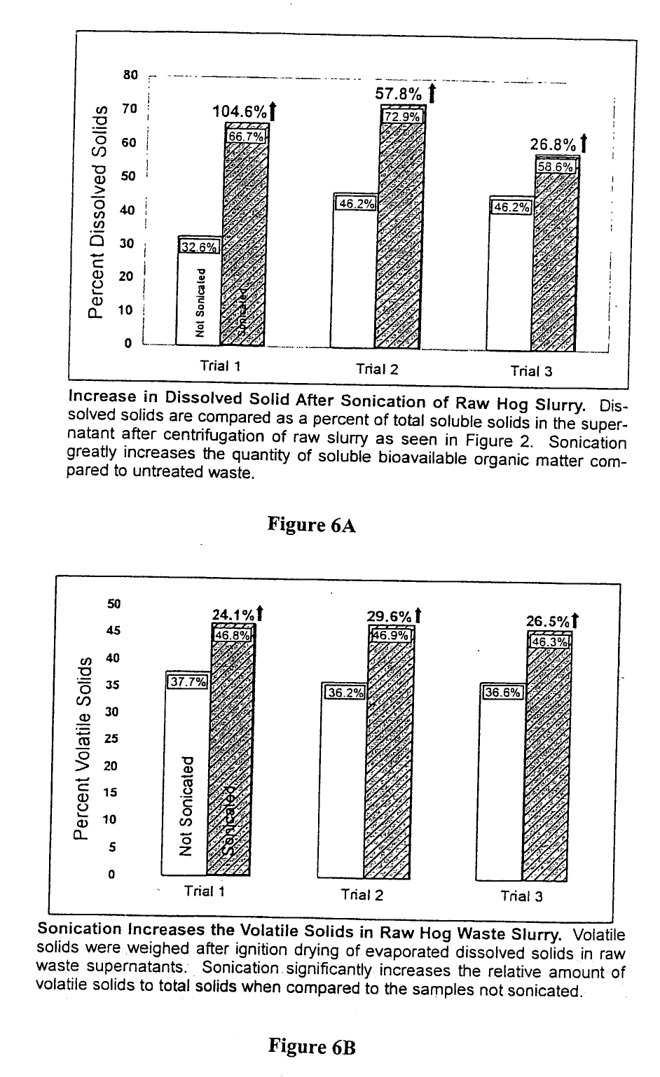

To test the effects of ultrasound in the pretreatment of livestock waste, experiments were performed in the laboratory with fresh waste slurry from a confined animal feeding operation. The sonication apparatus used in these experiments was a model VCX 600 sonicator, manufactured by Sonics and Materials, Inc. Fifty ml samples of waste were treated in a stainless steel sonication chamber. The tip of a 13 mm probe was immersed into the sample and vibrated at a frequency of 20 kHz, which is the optimal frequency range for cavitation in a liquid. Of course, other frequencies in the 5 to 100 kHz range would also have been effective to the extent that sufficient cavitational forces could be created. Various power settings were tested. A setting of 40% amplitude on this particular machine gave good results, although this may not be the exact power setting for achieving the best effect. Physico-Chemical analysis was performed according to STANDARD METHODS FOR THE EXAMINATION OF WASTE AND WASTEWATER, 18th ed. (APHA). Tests included chemical oxygen demand, total solids dried at 103° to 105° C., total suspended solids, and volatile solids (FIGS. 6-12).

The results showed the benefit of ultrasound pretreatment to liquid swine waste in both aerobic and anaerobic treatment systems. In aerobic experiments, 10 ml of sonicated or nonsonicated waste was inoculated with 40 ml of dilution water containing a standardized seed source of microorganisms capable of oxidizing the biodegradable organic matter in the sample. The samples were then oxygenated on a shaker bath at 25° C. for a 20-hour period.

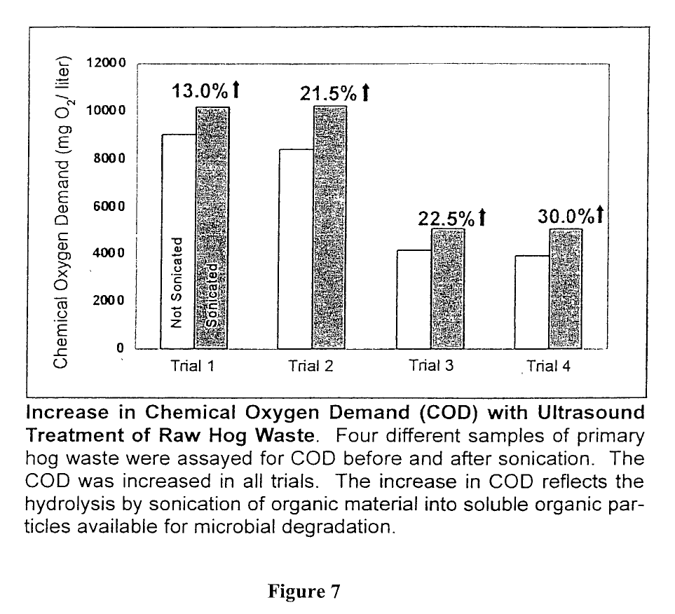

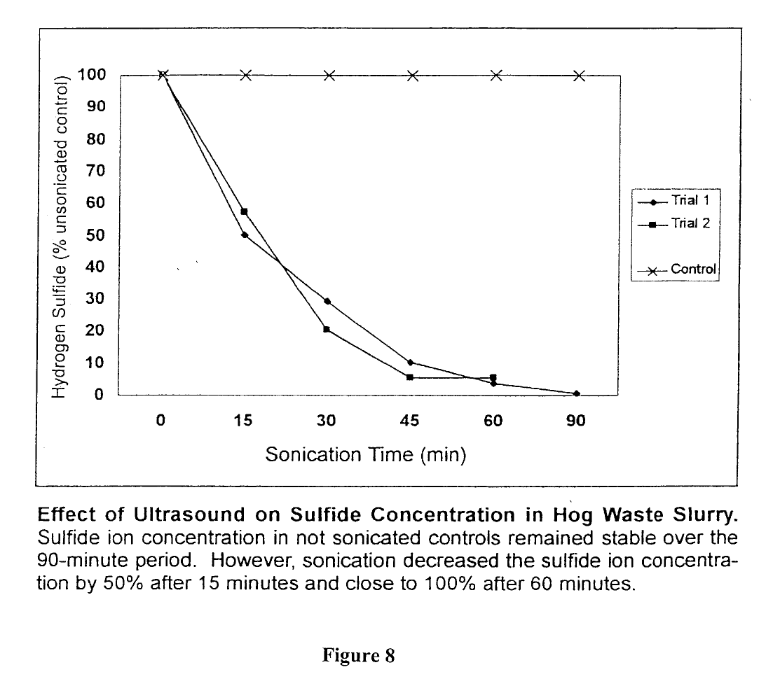

Sonication reduced the particle size of raw hog waste, as demonstrated in FIG. 5, in which particle images were obtained through a Zeiss Axioplan II microscope. Sonication increased dissolved solids. While high speed centrifugation pelleted untreated waste, it did not pellet ultrasound-treated waste. Sonication increased the percent suspended solids (FIG. 6A) and volatile solids (FIG. 6B). It also caused increases of between 13 and 30% in chemical oxygen demand (FIG. 7). Finally, sonication effectively removed hydrogen sulfide from hog waste slurries (FIG. 8).

As shown in FIG. 6 sonicated waste has a profound increase in the percentages of dissolved and volatile solids. In addition, as shown in FIG. 7, the chemical oxygen demand is also enhanced by sonication. Both the percentage of volatile solids and the chemical oxygen demand are indicators of an increased capacity for biodegradation.

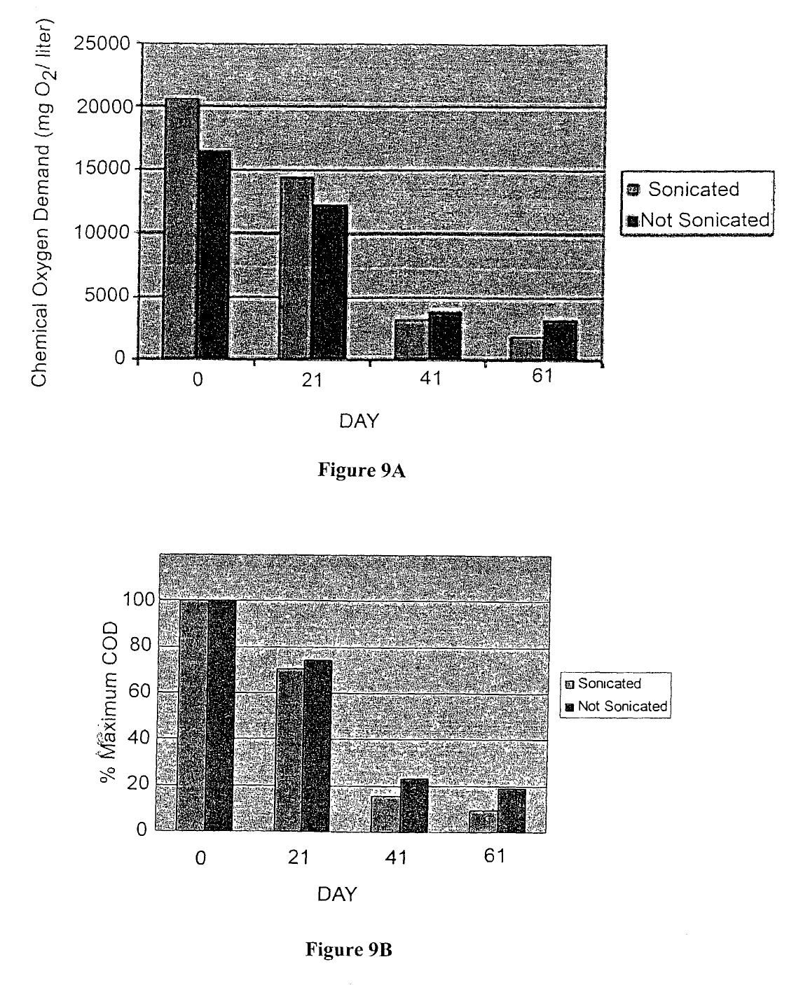

An anaerobic biological reactor was used to show how sonicated waste and nonsonicated waste were degraded. One reactor was fed with sonicated waste material (test) and the other (control) with an equal volume of non-sonicated waste material. The operating volume of the reactors was 4 liters. The system was initiated by the addition of 3 liters of water. The system was acclimatized to swine waste by daily addition of 200 ml of undiluted slurry (influent) and the removal of 200 ml (effluent) for a period of 20 days. Measurements were taken of the influent chemical oxygen demand and compared to the effluent on day 41 and day 61 (FIG. 9A).

Immediately after sonication, the actual chemical oxygen demand was approximately 20% higher in treated material. After 61 days, the actual chemical oxygen demand in the reactor with sonicated waste had decreased to 9% of the initial chemical oxygen demand, while that of the reactor with non-sonicated wasted had decrease to 19% of the initial chemical oxygen demand (FIG. 9B). Therefore, sonication caused an initial speed up in oxygen demand through 21 days that was then followed by a significant reduction by 61 days. The levels of hydrogen sulfide as well as the subjective obnoxious odor levels were reduced (data not shown).

The present inventors developed a model that imitated the recycling system that has been introduced into hog confinement facilities. The sonication chamber had a volume of five liters and included three sonication probes. In the model, 175 liters of liquefied swine waste were added to each of four 245-liter containers; the waste from each container being used in a separate experiment, as hereafter described in detail. Each day for five consecutive days, five liters from each container were pumped into the sonication chamber, treated, and then either returned to the original large container or aerated and then returned.

There were four different treatment regimens in these experiments hereafter described as Group I, Group II, Group III, and Group IV.

Group I involved no sonication and no aeration. Five liters of waste were pumped into the sonication chamber, then pumped back into the original container. This was done seven times each day, for five days.

Group II involved no sonication but aeration. Five liters of waste were pumped into the sonication chamber, then pumped into a 50 liter container. This was done seven times, and when 35 liters were in the container, the waste was aerated for 16 hours (at 1.5 liters of air/minute) before being returned to the original container.

Group III involved sonication and aeration. Five liters of waste were pumped into the sonication chamber, sonicated for five minutes, then pumped to a 50 liter container. This was done seven times; when 35 liters were in the container, the waste was aerated for 16 hours (at 1.5 liters of air/minute) before being returned to the original container.

Group IV involved sonication and no aeration. Five liters of waste were pumped into the sonication chamber, sonicated for five minutes, then pumped back into the original container. This was done seven times each day, for five days.

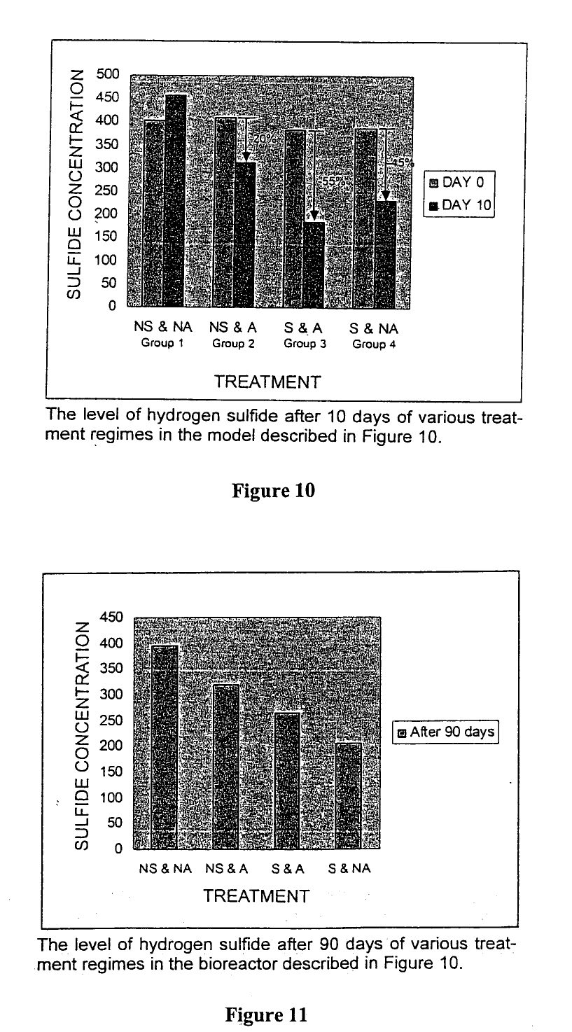

As shown in FIG. 10, after ten days the levels of hydrogen sulfide in the untreated material (Group I) was approximately the same as at day 0. However, the levels decreased by 20% in waste aerated but not treated with ultrasound (Group II), decreased by 45% in waste treated with ultrasound but not aerated (Group IV), and decreased by 55% in waste treated with ultrasound and aerated (Group III). Further, as shown in FIG. 11, after 90 days, the level of hydrogen sulfide in waste treated with ultrasound but not aerated was half that of untreated waste and even lower than waste treated with ultrasound and aerated.

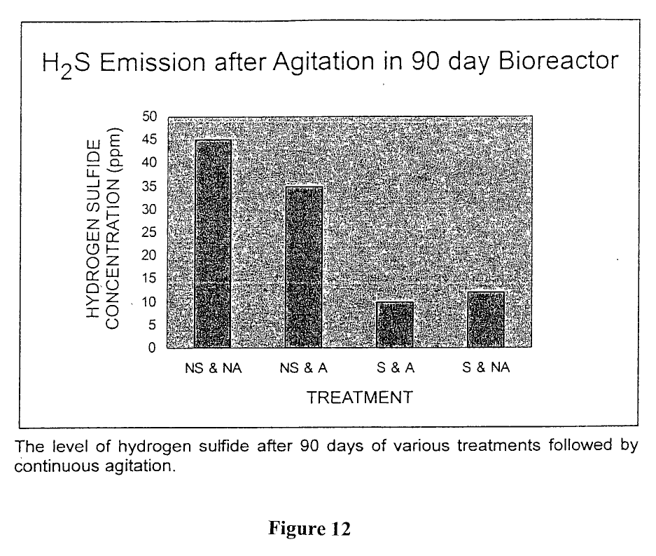

These results demonstrate that, when waste is sonicated and then stored for 10 and 60 days under the regime described, the level of hydrogen sulfide is reduced by about 45 and 50%, respectively. If the bioreactor is agitated continuously after treatment, hydrogen sulfide is reduced in the sonicated and aerated and in the sonicated but not aerated treatment regimes by 75%, when compared to untreated waste (FIG. 12).

In addition to hydrogen sulfide, ammonia emission and chemical oxygen were analyzed. Reproducible decreases in ammonia emissions and chemical oxygen demand were measured in the sonicated groups.

Although the aforementioned describes preferred embodiments of the invention, the invention is not so restricted. It will be apparent to those skilled in the art that various modifications and variations can be made to the disclosed preferred embodiments of the present invention without departing from the scope or spirit of the invention. For example, rather than being pumped out of a slurry pit, the waste could be pumped out of a lagoon, a storage tank, or a biorector and then be sonicated according to the systems described herein. Accordingly, it should be understood that the apparatus and method described herein are illustrative only and are not limiting upon the scope of the invention, which is indicated by the following claims. Accordingly, alternatives which would be obvious to one of ordinary skill in the art upon reading the teachings herein disclosed, are hereby within the scope of this invention.

What is claimed is:

1. A sonication apparatus for treating a fluid having solid biological waste therein, the apparatus comprising:
a substantially cylindrical sidewall defining a chamber having a longitudinal axis therethrough;
an inlet port provided at a first end of the sidewall;
an outlet port in fluid communication with the inlet port and provided at a second end of the sidewall;
a plurality of transducers arranged in a substantially linear manner, wherein each of the transducers is oriented substantially normal to the axis of the chamber, wherein the transducers are substantially provided on an exterior side of the sidewall, wherein each of the transducers comprises a probe which extends at least partially into the chamber,
wherein when the fluid having solid biological waste therein is provided in the chamber and the probes are at least partially emerged in the fluid, the probes are adapted to emit sound having a frequency adapted to facilitate dissolving or suspending the solid biological waste in the fluid.

2. The apparatus according to claim 1, further comprising:
a controller adapted to cause each of said probes to emit sound simultaneously.

3. The apparatus according to claim 1, wherein the probes are adapted to emit sound having a frequency between about 5 kHz and about 100 kHz.

4. The apparatus according to claim 1, wherein the probes are adapted to emit sound having a frequency of about 20 kHz.

5. The apparatus according to claim 2, wherein the controller is adapted to cause the probes to emit sound constantly for between about one minute and about ten minutes.

6. The apparatus according to claim 2, wherein the controller is adapted to cause the probes to emit sound constantly for about five minutes.

7. A sonication system for treating a fluid having solid biological waste therein, the system comprising:
a source containing the fluid having the solid, biological waste therein;
a pump, wherein an inlet to the pump is connected to a first pipe which is in fluid communication with the source, and wherein an outlet of the pump is connected to a second pipe;
a sonication apparatus comprising:
a substantially cylindrical sidewall defining a chamber having a longitudinal axis therethrough;
an inlet port provided at a first end of the sidewall, the inlet being connect to the second pipe;
an outlet port in fluid communication with the inlet port and provided at a second end of the sidewall;
a plurality of transducers arranged in a substantially linear manner, wherein each of the transducers is oriented substantially normal to the axis of the chamber, wherein the transducers are substantially provided on an exterior side of the sidewall, wherein each of the transducers comprises a probe which extends at least partially into the chamber;
a third pipe in fluid communication with the outlet port of the sonication apparatus, wherein when the fluid having solid biological waste therein is provided in the chamber and the probes are at least partially emerged in the fluid, the probes are adapted to emit sound having a frequency adapted to facilitate dissolving or suspending the solid biological waste in the fluid.

8. The system according to claim 7, wherein the third pipe is also in fluid communication with the source.

9. The system according to claim 7, wherein the third pipe is also in fluid communication with a lagoon, a storage tank, or a bioreactor.

10. The system according to claim 7, further comprising:
a controller adapted to control a flow of power to the probes, and wherein the controller is adapted to cause each of said probes to emit sound simultaneously.

11. The system according to claim 10, wherein the controller is adapted to control a flow of power to the pump.

12. The system according to claim 11, wherein the controller is adapted to alternate a supply power to the probes and to the pump.

13. The system according to claim 7, wherein the probes are adapted to emit sound having a frequency between about 5 kHz and about 100 kHz.

14. The system according to claim 7, wherein the probes are adapted to emit sound having a frequency of about 20 kHz.

15. The system according to claim 7, further comprising:
at least one of a flow rate monitor which is adapted to monitor the flow rate of the fluid having the solid biological waste therein when moving into the chamber, and a timer adapted to determine, based on a fixed flow rate, when the chamber is full of the fluid having the biological waste therein.

16. The system according to claim 15, further comprising:
a controller adapted to control a flow of power to the probes, and wherein the controller is adapted to cause each of said probes to emit sound simultaneously.

17. The system according to claim 15, wherein the controller is adapted to control a flow of power to the pump.

18. The system according to claim 16, wherein the controller is electrically connected to the flow rate monitor.

19. The system according to claim 18, wherein the controller is adapted to determine when the chamber is full of the fluid having the solid biological waste therein, the determination being based on the flow rate measured by the flow rate monitor and the volume of the chamber.

20. The system according to claim 19, wherein when the controller determines that the chamber is full, the controller terminates a supply power to the pump and initiates a supply of power to the probes.

21. The system according to claim 10, wherein the controller adapted to control a flow of power to the probes, and wherein the controller comprises a timer.

22. The system according to claim 21, wherein the controller is adapted to use the timer to determine when the chamber is full of the liquid having the solid biological waste therein at which time power to the pump is discontinued and power to the sonication apparatus is initiated.

23. The system according to claim 10, wherein the controller is adapted to cause the probes to emit sound constantly for between about one minute and ten minutes.

24. The system according to claim 10, wherein the controller is adapted to cause the probes to emit sound constantly for about five minutes.

25. The system according to claim 7, wherein the fluid having the solid biological waste therein continuously flows through the chamber.

26. A sonication system for treating a fluid having solid biological waste therein, the system comprising:
a source containing the fluid having the solid biological waste therein;
a pump, wherein an inlet to the pump is connected to a first pipe which is in fluid communication with the source, and wherein an outlet of the pump is connected to a second pipe;
a sonication apparatus comprising:
an inlet port provided at a first end thereof, the inlet being connect to the second pipe;
an outlet port in fluid communication with the inlet port and provided at a second end thereof;
a plurality of transducers each of which comprises a probe;
a third pipe in fluid communication with the outlet port of the sonication apparatus and at least one of the source, a lagoon, a storage tank, or a bioreactor,
wherein when the fluid having solid biological waste therein is provided in the sonication apparatus, the probes are adapted to emit sound having a frequency adapted to facilitate dissolving or suspending the solid biological waste in the fluid.

27. The system according to claim 26, wherein the transducers are provided in a substantially linear manner along an exterior side of the sonication apparatus.

28. The system according to claim 26, further comprising:
a controller adapted to control a flow of power to the probes, and wherein the controller is adapted to cause each of said probes to emit sound simultaneously.

29. The system according to claim 28, wherein the controller is adapted to control a flow of power to the pump.

30. The system according to claim 29, wherein the controller is adapted to alternate a supply power to the probes and to the pump.

31. The system according to claim 26, wherein the probes are adapted to emit sound having a frequency between about 5 kHz and 100 kHz.

32. The system according to claim 26, wherein the probes are adapted to emit sound having a frequency of about 20 kHz.

33. The system according to claim 26, further comprising:
a flow rate monitor which is adapted to monitor the flow rate of the fluid having the solid biological waste therein when moving into the sonication apparatus.

34. The system according to claim 33, further comprising:
a controller adapted to control a flow of power to the probes, and wherein the controller is adapted to cause each of said probes to emit sound simultaneously.

35. The system according to claim 33, wherein the controller is adapted to control a flow of power to the pump.

36. The system according to claim 34, wherein the controller is electrically connected to the flow rate monitor.

37. The system according to claim 36, wherein the controller is adapted to determine when the chamber is full of the fluid having the solid biological waste therein, the determination being based on the flow rate measured by the flow rate monitor and the volume of the chamber.

38. The system according to claim 37, wherein when the controller determines that the chamber is full, the controller terminates a supply power to the pump and initiates a supply of power to the probes.

39. The system according to claim 34, wherein the controller is adapted to cause the probes to emit sound constantly for between about one minute and ten minutes.

40. The system according to claim 39, wherein the controller is adapted to cause the probes to emit sound constantly for about five minutes.

41. The system according to claim 26, wherein the fluid having the solid biological waste therein continuously flows through the sonication apparatus.

42. A method of controlling a sonication system for treating a fluid having solid biological waste therein, wherein the system comprises a pump; a sonication chamber in fluid communication with the pump and comprising a plurality of probes each of which is adapted to emit sound having a frequency adapted to facilitate dissolving or suspending the solid biological waste in the fluid; a flow rate monitor adapted to monitor the flow rate of the fluid having solid biological waste therein when moving into the chamber, the method comprising the steps of:
providing a source containing the fluid having the solid biological waste therein, the source being in fluid communication with the pump;
determining when the chamber is full of the fluid having the solid biological waste therein, the determination being undertaken by a controller and being based on the flow rate measured by the flow rate monitor and the volume of the chamber, the flow rate monitor being electrically connected to the controller;
terminating, by means of the controller, the flow of power to the pump when the controller determines that the chamber is full; and
initiating a flow of power to the probes after terminating the flow of power to the pump, wherein the controller is adapted to cause each of said probes to emit sound simultaneously.

43. The method according to claim 42, further comprising the steps of:
terminating the flow of power to the probes after a predetermined period of time in which at least some of the solid biological waste becomes dissolved or suspended in the fluid in response to the sound emitted by the probes;
re-initiating a flow of power to the pump after terminating the flow of power to the probes; and
replacing the fluid having the biological waste dissolved or suspended therein in the chamber with a new quantity fluid having solid biological waste therein as pumped out of the source by the pump, when the flow of power is re-initiated in the pump.

44. The method according to claim 42, wherein the probes are adapted to emit sound having a frequency between about 5 kHz and 100 kHz.

45. The method according to claim 42, wherein the probes are adapted to emit sound having a frequency of about 20 kHz.

46. The method according to claim 42, wherein the step of initiating a flow of power to the probes has a duration of about one minute to about ten minutes.

47. The method according to claim 42, wherein the step of initiating a flow of power to the probes has a duration of about five minutes.

48. A method of treating a fluid that contains solid biological waste, using a system that comprises a pump; a sonication chamber in fluid communication with the pump, and a plurality of probes, wherein each probe of said plurality is adapted to emit sound having a frequency adapted to facilitate dissolving or suspending the solid biological waste in the fluid, the method comprising the steps of:
providing a source containing the fluid having the solid biological waste therein, the source being in fluid communication with the pump;
pumping the fluid from the source and into the sonication chamber;
determining when the chamber is full of the fluid having the solid biological waste therein, the determination being undertaken by a controller;
sonicating the fluid in the chamber for a predetermined period of time to yield sonicated fluid; and
moving the sonicated fluid into at least one of the source, a lagoon, a storage tank, or a bioreactor.
